(19) United States
(12) Patent Application Publication
(10) Pub. No.: US 2002/0029085 A1
(43) Pub. Date: Mar. 7, 2002

(54) System for automatic control of building

(76) Inventor: Kang Duk Park, Kwangju-si (KR)

Correspondence Address: SHLESINGER, ARKWRIGHT & GARVEY LLP, 3000 South Eads Street, Arlington, VA, 22202, US

(21) Appl. No.: 09/798,922

(22) Filed: Mar. 6, 2001

(30) Foreign Application Priority Data
Sep. 1, 2000 (KR) 2000-51596

(51) Int. Cl. G05B 11/01; G01M 1/38; G05B 13/00; G05B 15/00; G05B 21/00; G05D 23/00

(52) U.S. Cl. 700/19; 700/276

(57) ABSTRACT

The present invention relates to an automatic building control system for electric appliance control, fire monitoring, security monitoring and other operations of a residential or business-purposed building. An information communication technology based on a host computer and a local system control unit is employed for the automatic control of the building. Electric appliances in the building are connected in common to a single signal line and assigned unique addresses to realize simple piped and wired structures easy to change in design, thereby minimizing the amount of time and labor required for the construction process and hardships resulting from the design change.

### BACKGROUND OF THE INVENTION

1. Field of the Invention

The present invention relates in general to systems for automatic control of residential or business-purposed buildings, which are capable of automatically controlling electric appliance control, fire monitoring, security monitoring and other operations of the buildings, and more particularly to an automatic building control system which can be implemented with simple piped and wired structures easy to change in design, on the basis of unique addresses and control commands of control units, thereby preventing unnecessary power consumption, safety hazards, intrusion and the like at a low maintenance cost.

2. Description of the Prior Art

Larger and higher buildings have recently been constructed for the purpose of efficiently enlarging residential and business-purposed spaces. Further, with the development of information communication technologies, there have been proposed building automation systems for performing electric appliance (for example, electric lamps, etc.) control, fire and gas monitoring, security monitoring and other operations of buildings.

FIG. 1 is a circuit diagram showing the construction of a conventional building automation system. As shown in this drawing, power connection means 4 supplies external power to electric appliances in a building, such as lighting devices 1, a variety of sensors 2 including fire and gas sensors, and local switches 3. The lighting devices 1, sensors 2, local switches 3 and other electric appliances are individually wired to a central control unit 8.

The lighting devices 1 are connected to the central control unit 8 via switching means 5 consisting of a group of relays and a group of switches, and the sensors 2 and local switches 3 are connected to the central control unit 8 via terminal means 6 and an input/output control unit 7.

The central control unit 8 transmits and receives respective ON/OFF control signals of the lighting devices 1, sensors 2 and local switches 3 through the switching means 5, terminal means 6 and input/output control unit 7, individually wired to the associated electric appliances.

This complex wired structure causes the conventional building automation system to accommodate a limited number of electric appliances such as the lighting devices 1, switches 3 and sensors 2. For additional electric appliances, separate wires must be provided, resulting in a complexity and difficulty in construction.

Further, it is conventionally impossible to apply information communication technologies to buildings having building automation systems. Namely, the existing piping and wiring designs of such a building must often be changed for the application of information communication technologies, which may be mismatched with the construction of the building. Moreover, for the application of information communication technologies, the construction process must be subdivided or may encounter a difficulty resulting from the design change.

As buildings become higher and larger, the ratio of power required for lighting, heating and cooling to the entire power consumed has gradually increased, which is followed by a need for measures for preventing unnecessary power consumption. However, heavy expenses must conventionally be paid for the maintenance of buildings owing to the absence of efficient power management and power-saving measures. Moreover, conventional building automation systems are high in initial facility investment cost and must be managed by expert persons, resulting in an increase in maintenance cost. Furthermore, conventional building automation systems have no appropriate equipment for the prevention of safety hazards.

### SUMMARY OF THE INVENTION

Therefore, the present invention has been made in view of the above problems, and it is an object of the present invention to provide an automatic building control system wherein an information communication technology is employed for the automatic control of a building, electric appliances in the building are assigned unique addresses to realize simple piped and wired structures easy to change in design, thereby minimizing the amount of time and labor required for the construction process and hardships resulting from the design change, and a communication network is provided to perform the overall monitoring and control of the electric appliances and wired or wireless notification and alarm functions as a result of the monitoring and control, thereby lowering a maintenance cost of the building, reducing energy consumption through efficient power-saving management, accurately detecting dangerous accidents and providing rapid responses to the detected dangerous accidents.

In accordance with the present invention, the above and other objects can be accomplished by the provision of an automatic building control system comprising a plurality of tributary units connected in common to a single signal line in a building and assigned unique addresses, respectively, the tributary units generating tributary operation information containing information about their unique addresses and current operation states; at least one local system control means for generating command signals for the control of the tributary units in response to the tributary operation information from the tributary units, transmitting the generated command signals to the tributary units, monitoring and controlling operations of the tributary units and generating system control information as a result of the monitoring and control; and a host computer for assigning an address to the local system control means, exchanging data therewith and controlling the arrangement and connection of the tributary units and the entire system operation in response to the system control information from the local system control means or under the control of an operator.

Preferably, the local system control means may be integrated with the host computer to transfer information about abnormal states of the tributary units and alarm signals to the operator over a wired or wireless communication network and generate the system control information under the control of the operator, and the tributary units may include electric appliances driven in response to power supplied through interior wiring of the building, the electric appliances being lighting means, switching means, sensing means and receptacles.

More preferably, the lighting means, switching means and receptacles may be connected to the local system control means in a two-line way for signal transfer and the sensing means may be connected to the local system control means in a four-line way for signal transfer and emergency power connection.

Preferably, the local system control means may include a power supply for supplying power to the system; a reset circuit for initializing the system; central processing means initialized in response to a power signal from the power supply and a reset signal from the reset circuit, the central processing means monitoring and controlling communication between the host computer and the tributary units synchronously with a clock signal for synchronization of the system; an address decoder for performing an address decoding operation under the control of the central processing means; a random access memory for storing address information and a variety of information inputted and outputted to/from the central processing means; a first communication unit for performing transmission and reception of data and signals between the central processing means and the host computer; a second communication unit for performing transmission and reception of data and signals between the central processing means and the tributary units; and a key input unit for inputting key signals entered by the operator and transferring the inputted key signals to the central processing means.

More preferably, the central processing means may include a main central processing unit for performing communication with the host computer through the first communication unit; and a sub central processing unit for performing communication with the tributary units through the second communication unit and input/output control operations in response to the key signals inputted by the key input unit.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a circuit diagram showing the construction of a conventional building automation system;

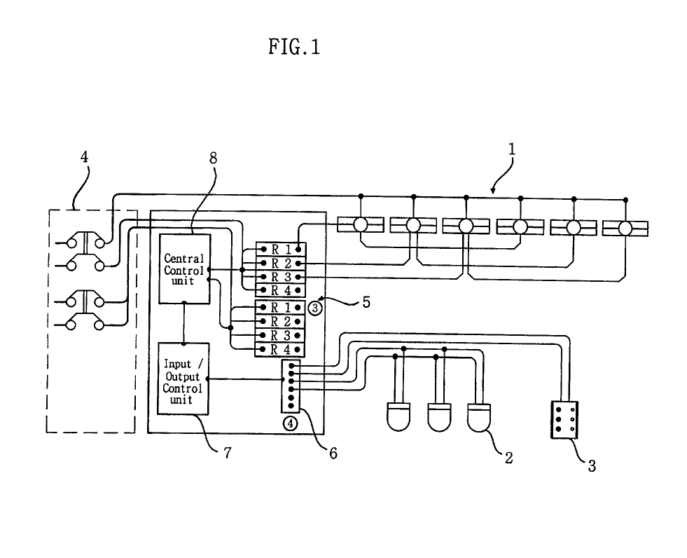

FIG. 2 is a block diagram showing the entire construction of an automatic building control system in accordance with the present invention; and

FIG. 3 is a block diagram showing the construction of a local system control unit in FIG. 2.

### DETAILED DESCRIPTION OF THE PREFERRED EMBODIMENTS

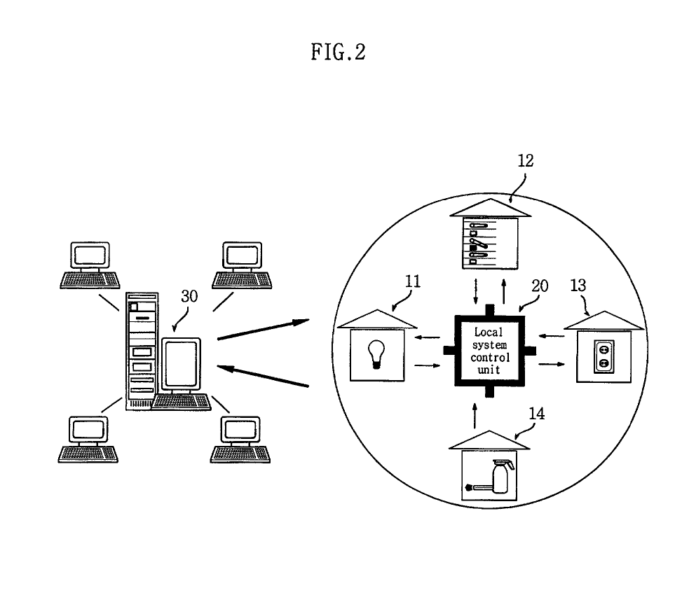

With reference to FIG. 2, there is shown in block form the entire construction of an automatic building control system in accordance with the present invention. As shown in this drawing, the automatic building control system comprises a plurality of tributary units connected in common to a single signal line in a building and assigned unique addresses, respectively, a local system control unit 20 for monitoring and controlling the operations of the tributary units, and a host computer 30 for exchanging data with the local system control unit 20 and controlling the arrangement and connection of the tributary units and the entire system operation under the control of an operator.

Preferably, the local system control unit 20 acts as a relay station between the tributary units and the host computer 30. Alternatively, the local system control unit 20 may be integrated with the host computer 30 to transfer information or an alarm signal to the operator over a wired or wireless communication network and directly control the arrangement and connection of the tributary units, a control program modification and other operations under the control of the operator.

The tributary units include electric appliances such as lighting means 11, for example, fluorescent lamps driven in response to power supplied through interior wiring of the building, switching means 12 for turning on/off the lighting means 11 and other associated electric appliances, receptacles 13 for receiving plugs of associated electric appliances to transfer power thereto, and sensing means 14, for example, fire, gas and burglar sensors.

In the present embodiment, the same number of tributary units as that (for example, 2¹⁶) of addresses assigned to the local system control unit 20 can be installed. In the case where a new tributary unit is additionally installed, the local system control unit 20 senses the addition of the new tributary unit and checks its unique address. In this manner, the local system control unit 20 performs the overall monitoring and control of the tributary units.

The tributary units are connected to the local system control unit 20 in a two-line way for signal transfer. However, the sensing means 14 among the tributary units are connected to the local system control unit 20 in a four-line way for signal transfer and emergency power connection.

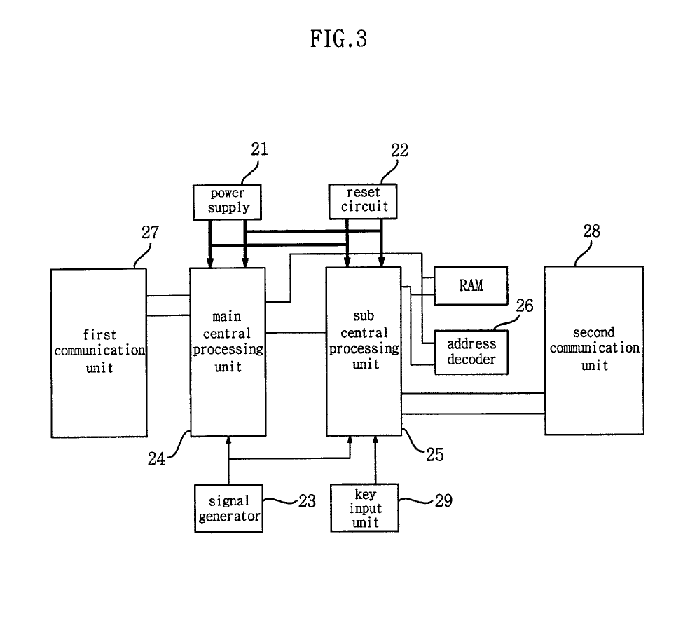

The local system control unit 20 includes, as shown in FIG. 3, a power supply 21 for supplying power to the system, a reset circuit 22 for initializing the system, a signal generator 23 for generating a clock signal for synchronization of the system in response to a power signal from the power supply 21 and a reset signal from the reset circuit 22, central processing means for monitoring and controlling communication between the host computer 30 and the tributary units synchronously with the clock signal from the signal generator 23, an address decoder 26 for performing an address decoding operation under the control of the central processing means, a random access memory (RAM) for storing address information and a variety of information inputted and outputted to/from the central processing means, a first communication unit 27 for performing transmission and reception of data and signals between the central processing means and the host computer 30, a second communication unit 28 for performing transmission and reception of data and signals between the central processing means and the tributary units, and a key input unit 29 for inputting key signals entered by the operator and transferring the inputted key signals to the central processing means.

The central processing means includes a main central processing unit 24 for performing communication with the host computer 30 through the first communication unit 27, and a sub central processing unit 25 for performing communication with the tributary units through the second communication unit 28 and input/output control operations in response to the key signals inputted by the key input unit 29.

A detailed description will hereinafter be given of the operation of the automatic building control system with the above-stated construction in accordance with the present invention.

First, for the automatic control of a building using an information communication technology, a wired or wireless communication network is provided between the local system control unit 20 and the host computer 30.

Then, the host computer 30 determines arrangement and connection structures of the tributary units under the control of the operator and sends the determined results to the local system control unit 20. It should be noted that a plurality of local system control units may be installed for the control of local areas in one building. In this case, unique addresses are assigned respectively to the local system control units such that the host computer 30 controls the local system control units individually.

The local system control unit 20 functions as a relay station between the host computer 30 and the tributary units. Namely, the local system control unit 20 sends information about its unique address and the current system operation state to the host computer 30 and performs the overall monitoring and control of the tributary units.

In more detail, the local system control unit 20 communicates with the host computer 30 and the tributary units, respectively, through the first and second communication units 27 and 28 as shown in FIG. 3. The central processing means receives information about addresses of the tributary units and the current operation states thereof through the second communication unit 28, analyzes the received information and generates command signals as a result of the analysis.

Upon detecting an abnormal state of at least one of the tributary units while continuously monitoring the tributary units, the local system control unit 20 gives an alarm signal to the operator over the wired or wireless communication network. Further, the local system control unit 20 accurately identifies the kind and position of the abnormal tributary unit and notifies the operator of the identified kind and position. Then, in response to the alarm signal, the operator notifies a building manager, firehouse, police station and the like of the abnormal state of the building such that they take active measures to respond to various dangerous accidents.

Further, in order to prevent a worsening of the abnormal state of the building while giving the alarm signal, the local system control unit 20 may turn off all power sources and gas valves in the building, actuate a fire alarm or automatic spread extinguisher or perform other self-initiated safety management functions.

The tributary units include electric appliances which are driven in response to power supplied through interior wiring of the building, connected in common to a single signal line and assigned unique addresses. The electric appliances may be, for example, the lighting means 11, switching means 12, receptacles 13 and sensing means 14. In the case where the supply or interruption of power to the tributary units is requested by the control of a user or other remote control, the tributary units generate tributary operation information in response to the power supply or interruption request and send the generated information to the local system control unit 20.

The tributary operation information from the tributary units preferably includes information about unique addresses of the tributary units and the current operation states thereof. This operation information is transmitted to the local system control unit 20 over the signal line. Hence, the local system control unit 20 analyzes the transmitted tributary operation information and recognizes the unique addresses of the tributary units as a result of the analysis. The local system control unit 20 also generates command signals in response to the power supply or interruption request and sends the generated command signals to the tributary units.

Accordingly, the command signals from the local system control unit 20 are sent to the tributary units over the signal line. At this time, the sent command signals contain addresses of tributary units designated by the local system control unit 20. As a result, only the tributary units designated by the local system control unit 20 perform operations associated with the sent command signals.

In this way, the tributary units share a single signal line, thereby making the system installation very simple. In the case where a new tributary unit is additionally installed, it is connected to a line branching from the single signal line, so that the system design can readily be modified.

As apparent from the above description, the present invention provide an automatic building control system wherein an information communication technology based on a host computer and a local system control unit is employed for the automatic control of a building. Electric appliances in the building are connected in common to a single signal line and assigned unique addresses to realize simple piped and wired structures easy to change in design, thereby minimizing the amount of time and labor required for the construction process and hardships resulting from the design change. Further, the addition of a new unit or the removal of an existing unit can readily be realized by adding or removing an associated line branching from the single signal line and checking an associated address. Furthermore, a communication network is provided to perform the overall monitoring and control of the electric appliances and wired or wireless notification and alarm functions as a result of the monitoring and control, thereby lowering a maintenance cost of the building, reducing energy consumption through efficient power-saving management, accurately detecting abnormal states of units and providing rapid responses to the detected abnormal states.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An automatic building control system comprising:
a plurality of tributary units connected in common to a single signal line in a building and assigned unique addresses, respectively, said tributary units generating tributary operation information containing information about their unique addresses and current operation states;
at least one local system control means for generating command signals for the control of said tributary units in response to said tributary operation information from said tributary units, transmitting the generated command signals to said tributary units, monitoring and controlling operations of said tributary units and generating system control information as a result of the monitoring and control; and
a host computer for assigning an address to said local system control means, exchanging data therewith and controlling the arrangement and connection of said tributary units and the entire system operation in response to said system control information from said local system control means or under the control of an operator.

2. An automatic building control system as set forth in claim 1, wherein said local system control means is integrated with said host computer.

3. An automatic building control system as set forth in claim 1 or claim 2, wherein said local system control means is adapted to transfer information about abnormal states of said tributary units and alarm signals to said operator over a wired or wireless communication network and generate said system control information under the control of said operator.

4. An automatic building control system as set forth in claim 1, wherein said tributary units include electric appliances driven in response to power supplied through interior wiring of the building, said electric appliances being lighting means, switching means, sensing means and receptacles.

5. An automatic building control system as set forth in claim 1 or claim 4, wherein said lighting means, switching means and receptacles are connected to said local system control means in a two-line way for signal transfer and said sensing means are connected to said local system control means in a four-line way for signal transfer and emergency power connection.

6. An automatic building control system as set forth in claim 1, wherein said local system control means includes:
a power supply for supplying power to the system;
a reset circuit for initializing the system;
central processing means initialized in response to a power signal from said power supply and a reset signal from said reset circuit, said central processing means monitoring and controlling communication between said host computer and said tributary units synchronously with a clock signal for synchronization of the system;
an address decoder for performing an address decoding operation under the control of said central processing means;
a random access memory for storing address information and a variety of information inputted and outputted to/from said central processing means;
a first communication unit for performing transmission and reception of data and signals between said central processing means and said host computer;
a second communication unit for performing transmission and reception of data and signals between said central processing means and said tributary units; and
a key input unit for inputting key signals entered by said operator and transferring the inputted key signals to said central processing means.

7. An automatic building control system as set forth in claim 6, wherein said central processing means includes:
a main central processing unit for performing communication with said host computer through said first communication unit; and
a sub central processing unit for performing communication with said tributary units through said second communication unit and input/output control operations in response to the key signals inputted by said key input unit.
